(19) United States
(12) Patent Application Publication
(10) Pub. No.: US 2026/0057720 A1
(43) Pub. Date: Feb. 26, 2026

(54) INVISIBLE E-LOCK DOOR AND ELECTRONIC DEVICE USING SAME

(71) Applicant: Delta Electronics, Inc., Taoyuan City (TW)

(72) Inventors: Chia-Hui Chen, Taoyuan City (TW); Yin-Chun Lan, Taoyuan City (TW)

(21) Appl. No.: 19/050,494

(22) Filed: Feb. 11, 2025

Related U.S. Application Data
(60) Provisional application No. 63/684,974, filed on Aug. 20, 2024.

(30) Foreign Application Priority Data
Dec. 20, 2024 (CN) 202423156020.6

(51) Int. Cl. G07C 9/00

(52) U.S. Cl. CPC G07C 9/00944; G07C 9/00182; G07C 2009/00769; G07C 2009/00976

(57) ABSTRACT

An invisible E-lock door and an electronic device using the same are disclosed. The invisible E-lock door includes a door panel body, an electronic lock and a shielding module. The door panel body is arranged on an opening of a cabinet, and configured to close or open the opening of the cabinet. The electronic lock is installed on the door panel body and includes a controller and a signal receiver. The signal receiver is connected to the controller and configured to receive an operation instruction sent via wireless transmission. The controller controls the electronic lock according to the operation instruction. The shielding module is spatially corresponding to the electronic lock, and configured to selectively shield or expose the electronic lock. The invisible E-lock allows a cloud-controlled door lock switch effectively controlling and confirming the opening and closing of the cabinet door through wireless transmission, when the electronic lock is invisible.

### CROSS-REFERENCE TO RELATED APPLICATION

This application claims the benefit of U.S. Provisional Application No. 63/684,974 filed on Aug. 20, 2024, and entitled “PLUGGABLE REMOTE ACTUATOR MODULE AND INVISIBLE E-LOCK DOOR”. This application claims priority to China Patent Application No. 202423156020.6, filed on Dec. 20, 2024. The entireties of the above-mentioned patent applications are incorporated herein by reference for all purposes.

### FIELD OF THE INVENTION

The present disclosure relates to an E-lock door structure, and more particularly to an invisible E-lock door and an electronic device using the same, having an invisible E-lock cooperated with a cloud-controlled door lock switch through wireless transmission connection, so as to control and confirm the opening and closing of the cabinet door effectively.

### BACKGROUND OF THE INVENTION

Generally, when the telecommunications network power is interrupted or fluctuates, the telecommunications power supply system can ensure the normal operation of telecommunications services. Therefore, the communication power supply systems have been widely used in various fields. Currently, most common communication power systems on the market are installed in a communication power cabinet. Moreover, the cabinet door is opened through a traditional handle, or a key is required to open the cabinet door. Since the handle is directly exposed, it cannot effectively prevent thieves, and the safety and anti-theft mechanism is insufficient.

On the other hand, the safety mechanism of the conventional communication power supply system cannot accurately record the date and time when the cabinet door is opened and closed. Certainly, users cannot use remote communication to connect to the system and receive the information about the opening or closing of the cabinet door immediately.

Therefore, there is a need of providing an invisible E-lock door and an electronic device using the same, having an invisible E-lock cooperated with a cloud-controlled door lock switch through wireless transmission connection, so as to control and confirm the opening and closing of the cabinet door effectively, and obviate the drawbacks encountered from the prior arts.

### SUMMARY OF THE INVENTION

It is an object of the present disclosure to provide an invisible E-lock door and an electronic device using the same, having an invisible E-lock cooperated with a cloud-controlled door lock switch through wireless transmission connection, so as to control and confirm the opening and closing of the cabinet door effectively.

It is another object of the present disclosure to provide an invisible E-lock door and an electronic device using the same. The invisible E-lock door includes a shielding module to construct a shielding space on the door panel body. An electronic lock is installed in the shielding space, and it allows choosing to shield or expose the electronic lock by operating the shielding module. The shielding module is operated by means of, for example, a pivoting cover or a sliding cover combined with a magnetic buckle, a butterfly hinge, a snap fastener or a magnetic switch, so that the shielding space is capable of being sealed to shield the electronic lock. Alternatively, the shielding space is capable of being opened to expose the electronic lock, thereby allowing the electronic lock to be exposed. In that, an invisible electronic lock is installed on the door panel body. In addition to providing basic protection functions for the electronic lock, it also helps to prevent the electronic lock from vandalism caused by man. On the other hand, the opening and closing operations of the electronic lock are controlled through the cloud-controlled door lock switch, so as to eliminate the inconvenience of users having to carry physical keys with them. The cloud-controlled door lock switch can send an operation instruction through a mobile application (APP), a user web page (WEB) or a radio frequency identification (RFID) system to the signal receiver of the electronic lock in a wireless transmission manner, and then the operation instruction is transmitted to the controller to control the opening and closing of the electronic lock, even if the electronic lock is still shield by the shielding module in an invisible state. In addition, the electronic lock received in the shielding space can be exposed by opening the shielding module when inspection or maintenance is required. Certainly, a card swipe machine can also be added to the electronic lock in the shielding space to realize the diverse applications of the invisible E-lock door. An electronic device such as the communication power supply cabinet can provide the system administrator with information about the opening or closing of the cabinet door immediately through the installation of the invisible E-lock door of the present disclosure, so as to further improve the security and anti-theft mechanism. At the same time, the related information can be collected through such mobile applications or user web pages for recording the date and time accurately when the cabinet door is opened and closed, so that the access control can be further strengthened. The present disclosure includes the industrial applicability and the inventive steps.

In accordance with an aspect of the present disclosure, an invisible E-lock door is provided and includes a door panel body, an electronic lock and a shielding module. The door panel body is arranged on an opening of a cabinet and configured to close or open the opening of the cabinet. The electronic lock is installed on the door panel body and includes a controller and a signal receiver, wherein the signal receiver is connected to the controller and configured to receive an operation instruction sent via wireless transmission and transmit the operation instruction to the controller, and the controller controls the electronic lock to turn on or turn off according to the operation instruction. The shielding module is spatially corresponding to the electronic lock, and configured to selectively shield or expose the electronic lock.

In an embodiment, the operation instruction is issued by a mobile application, a user web page or a radio frequency identification system.

In an embodiment, the shielding module includes a cover plate, which is pivotally connected to the door panel body, spatially corresponding to the electronic lock, and configured to form a shielding space in the door panel body, wherein the electronic lock is in communication with an exterior through the shielding space.

In an embodiment, the cover plate is connected to the door panel body through a magnetic buckle, a butterfly hinge or a snap fastener to seal the shielding space and shield the electronic lock.

In an embodiment, the cover plate is rotated away from the magnetic buckle, the butterfly hinge or the snap fastener to open the shielding space and expose the electronic lock.

In an embodiment, the shielding module includes a cover plate, which is slidably disposed on the door panel body, spatially corresponding to the electronic lock, and configured to form a shielding space in the door panel body, wherein the electronic lock is in communication with an exterior through the shielding space.

In an embodiment, the cover plate is connected to the door panel body through a magnetic switch to seal the shielding space and shield the electronic lock.

In an embodiment, the cover plate is slid away from the magnetic switch to open the shielding space and expose the electronic lock.

In an embodiment, the cover plate is slidably mounted on an installation housing through a sliding rail, the installation housing is embedded in the door panel body, and the sliding rail is parallel to a front plane of the door panel body.

In an embodiment, the cover plate is arranged at an inclination relative to a front plane of the door panel body.

In an embodiment, the cover plate is L-shaped and corresponding to a front plane and a lateral plane of the door panel body.

In an embodiment, the invisible E-lock door further includes a card swipe machine, wherein the card swipe machine is arranged adjacent to the electronic lock, accommodated in the sheltered space, and electrically connected to the controller.

In accordance with another aspect of the present disclosure, an electronic device using the invisible E-lock door is provided and includes a cloud-controlled door lock switch and an invisible E-lock door. The cloud-controlled door lock switch is configured to send an operation instruction through a wireless transmission manner. The invisible E-lock door is configured to be controlled by the cloud-controlled door lock switch and includes a door panel body, an electronic lock and a shielding module. The door panel body is arranged on an opening of a cabinet and configured to close or open the opening of the cabinet. The electronic lock is installed on the door panel body and includes a controller and a signal receiver, wherein the signal receiver is connected to the controller and configured to receive the operation instruction sent by the cloud-controlled door lock switch and transmit the operation instruction to the controller, and the controller controls the electronic lock to turn on or turn off according to the operation instruction. The shielding module is spatially corresponding to the electronic lock, and configured to selectively shield or expose the electronic lock.

In an embodiment, the cloud-controlled door lock switch includes a mobile application, a user web page or a radio frequency identification system.

In an embodiment, the shielding module further comprises an installation housing, which is detachably embedded in the door panel body and configured to form a shielding space, and the electronic lock is accommodated in the shielding space.

### BRIEF DESCRIPTION OF THE DRAWINGS

The above contents of the present disclosure will become more readily apparent to those ordinarily skilled in the art after reviewing the following detailed description and accompanying drawings, in which:

FIG. 1 is a structural perspective view illustrating an electronic device and an invisible E-lock door thereto according to a first embodiment of the present disclosure;

FIG. 2 is a schematic structural view illustrating the electronic device and the invisible E-lock door according to the first embodiment of the present disclosure;

FIGS. 3A to 3C show several exemplary structures of the shielding module in the invisible E-lock door of the present disclosure;

FIG. 4 is a structural perspective view illustrating an electronic device and an invisible E-lock door thereto according to a second embodiment of the present disclosure;

FIG. 5 is a schematic structural view illustrating the electronic device and the invisible E-lock door according to the second embodiment of the present disclosure; and

FIG. 6 shows an exemplary structure of the shielding module in the invisible E-lock door of the present disclosure.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed. Further, spatially relative terms, such as “upper,” “lower,” “front,” “rear,” “top,” “bottom,” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly. When an element is referred to as being “connected,” or “coupled,” to another element, it can be directly connected or coupled to the other element or intervening elements may be present. Although the wide numerical ranges and parameters of the present disclosure are approximations, numerical values are set forth in the specific examples as precisely as possible. In addition, although the “first,” “second” and the like terms in the claims be used to describe the various elements can be appreciated, these elements should not be limited by these terms, and these elements are described in the respective embodiments are used to express the different reference numerals, these terms are only used to distinguish one element from another element. For example, a first element could be termed a second element, and, similarly, a second element could be termed a first element, without departing from the scope of example embodiments. Besides, “and/or” and the like may be used herein for including any or all combinations of one or more of the associated listed items.

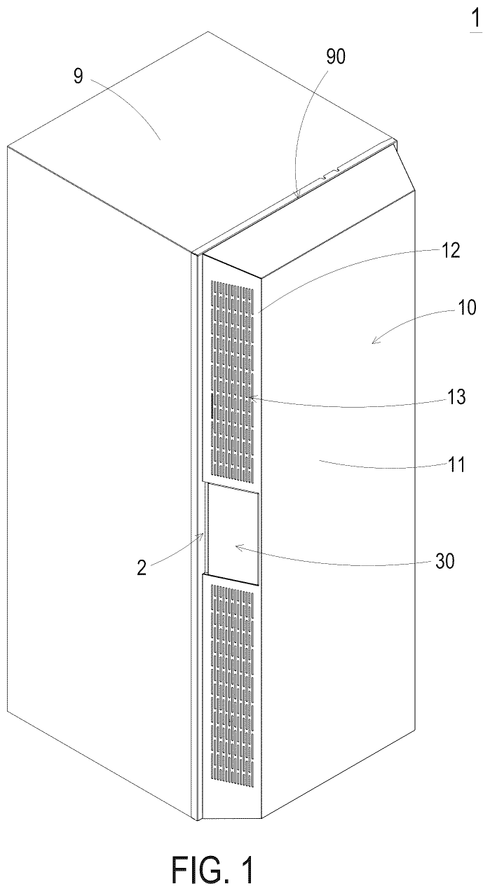

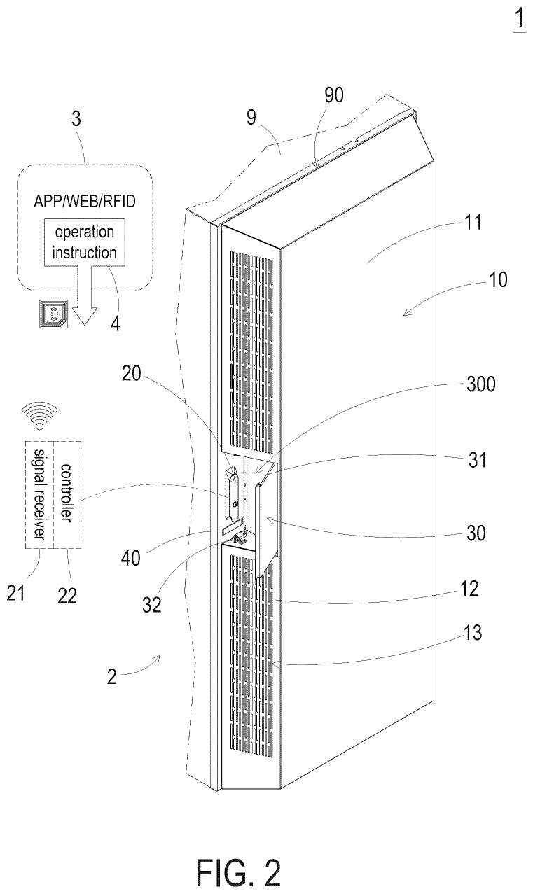

FIG. 1 is a structural perspective view illustrating an electronic device and an invisible E-lock door thereto according to a first embodiment of the present disclosure. FIG. 2 is a schematic structural view illustrating the electronic device and the invisible E-lock door according to the first embodiment of the present disclosure. Please refer to FIG. 1 and FIG. 2. In the embodiment, the present disclosure provides an electronic device 1 includes an invisible E-lock door 2. Preferably but not exclusively, the electronic device 1 is used in communication power systems, and includes a cloud-controlled door lock switch 3 and an invisible E-lock door 2. In the embodiment, the invisible E-lock door 2 is configured to be controlled by the cloud-controlled door lock switch 3. Preferably but not exclusively, the cloud-controlled door lock switch 3 refers to the software or hardware that can send operation instructions through a wireless transmission manner, such as a mobile application (APP), a user web page (WEB) or a radio frequency identification (RFID) system, so that the operation instructions can be sent through the wireless transmission manner by user operation. In the embodiment, the invisible E-lock door 2 includes a door panel body 10, an electronic lock 20 and a shielding module 30. The door panel body 10 is arranged on an opening 90 of a cabinet 9 and configured to close or open the opening 90 of the cabinet 9. Preferably but not exclusively, a server or power supply devices of a communication power supply system is accommodated in the cabinet 9 contains, and the present disclosure is not limited thereto. In the embodiment, the electronic lock 20 is installed on the door panel body 10 and arranged adjacent to the left side edge. Moreover, the electronic lock 20 includes a controller 22 and a signal receiver 21. Preferably but not exclusively, in other embodiment, the electronic lock 20 is disposed adjacent to the right side edge. In the embodiment, the signal receiver 21 is connected to the controller 22 and configured to receive the operation instruction 4 sent by the cloud-controlled door lock switch 3 in the wireless transmission manner and transmit the operation instruction 4 to the controller 22. In the embodiment, the controller 22 controls the electronic lock 20 to turn on or turn off according to the operation instruction 4. In other words, the opening and closing operations of the electronic lock 20 is controlled by the user operating the cloud-controlled door lock switch 3. For example, the smart phone carried by the user is used to realize the cloud control of the door lock switch 3. In that, the inconvenience of users having to carry physical keys with them is eliminated. Certainly, the operation scenario of the cloud-controlled door lock switch 3 is not limited thereto. Furthermore, in the embodiment, the shielding module 30 is spatially corresponding to the electronic lock 20, and configured to selectively shield or expose the electronic lock 20. In addition to providing basic protection functions for the electronic lock, it also helps to prevent the electronic lock from vandalism caused by man.

In the embodiment, the shielding module 30 is detachably embedded in the left side edge of the door panel body 10, and includes a cover plate 31. Preferably but not exclusively, the cover plate 31 is pivotally connected to the door panel body 10, spatially corresponding to the electronic lock 20, and configured to form a shielding space 300 in the door panel body 10. In the embodiment, the electronic lock 20 is in communication with an exterior through the shielding space 300. In the embodiment, the cover plate 31 is connected to the door panel body 10 through a magnetic buckle 32, so as to seal the shielding space 300 and shield the electronic lock 20. In addition, the cover plate 31 is allowed rotating away from the magnetic buckle 32, to open the shielding space 300 and expose the electronic lock 20. Thereby, the user can operate the cover plate 31 to choose to seal or open the shielding space 300. When the electronic lock 20 needs to be hidden, the cover plate 31 is operated to seal the shielding space 300. When the electronic lock 20 needs to be viewed, the cover plate 31 is operated to expose the electronic lock 20. Notably, when the cloud-controlled door lock switch 3 sends the operation instruction 4 to the signal receiver 21 of the invisible E-lock door 2 through the wireless transmission manner, the status of the cover plate 31 sealing or opening the shielded space 300 is not necessarily relevant. In other words, the user can complete the control of the electronic lock 20 by sending the operation instruction 4 through the APP of the cloud-controlled door lock switch 3, even if the shielding space is seal by the cover plate 31. The present disclosure is not limited thereto.

In the embodiment, the door panel body 10 further includes a bevel plane 12, which is connected between a front plane 11 of the door panel body 10 and the opening 90 of the cabinet 9. Preferably but not exclusively, a plurality of exhaust holes 13 are disposed on the bevel plane 12 for exhaust and heat dissipation. In the embodiment, the shielding module 30 is embedded into the bevel plane 12, so as to perform a basic concealment and protection function when the shielding space 300 is sealed by the cover plate 31. Furthermore, the user needs to face the bevel plane 12 when opening the cover plate 31 to open the shielded space 300, and it is conducive for others to observe the user's actions from the front plane 11 of the door panel body 10 and helps to prevent the electronic lock 20 from vandalism Certainly, the present disclosure is not limited thereto.

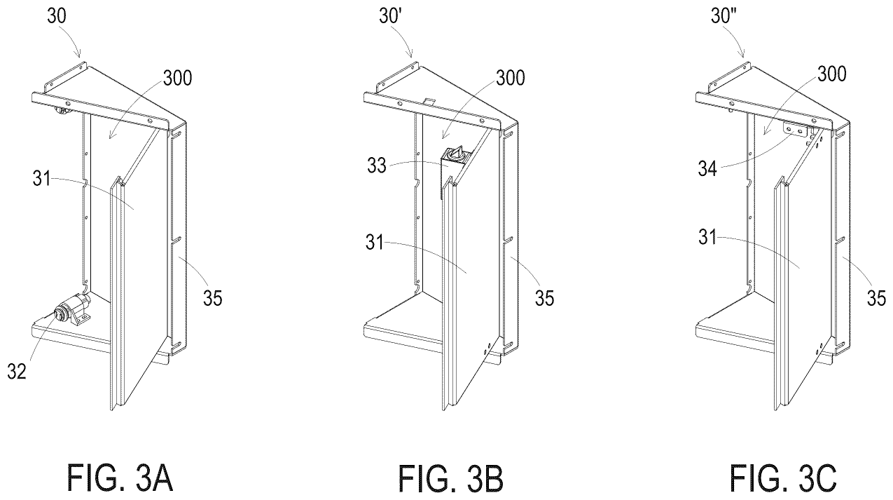

FIGS. 3A to 3C show several exemplary structures of the shielding module in the invisible E-lock door of the present disclosure. Please refer to FIG. 1, FIG. 2 and FIG. 3A to FIG. 3C. In the embodiment, in order to facilitate the shielding module 30 to be detachably embedded into the bevel plane 12 of the door panel body 10, the shielding module 30 further adopts a modular design. Preferably but not exclusively, the shielding module 30 includes an installation housing 35, and the cover plate 31 is pivotally connected to the installation housing 35. In addition, the magnetic buckle 32 is preset on the installation housing 35 to spatially correspond to the cover plate 31, as shown in FIG. 3A. In this way, the modular shielding module 30 can be detachably embedded into the bevel plane 12 of the door panel body 10 and corresponding to the position of the electronic lock 20, and the cover plate 31 is arranged at an inclination relative to the front plane 11 of the door panel body 10. In an embodiment, the cover plate 31 is combined with the operation of the snap fastener 33 to selectively seal the shielding space 300 and shield the electronic lock 20, or open the shielding space 300 and expose the electronic lock 20, as shown in FIG. 3B. In this way, the modular shielding module 30′ can be detachably embedded into the bevel plane 12 of the door panel body 10 and corresponding to the position of the electronic lock 20, and the cover plate 31 is arranged at an inclination relative to the front plane 11 of the door panel body 10. In another embodiment, the cover plate 31 is combined with the operation of the butterfly hinge 34 to selectively seal the shielding space 300 and shield the electronic lock 20, or open the shielding space 300 and expose the electronic lock 20, as shown in FIG. 3C. In this way, the modular shielding module 30″ can be detachably embedded into the bevel plane 12 of the door panel body 10 and corresponding to the position of the electronic lock 20, and the cover plate 31 is arranged at an inclination relative to the front plane 11 of the door panel body 10. Certainly, in other embodiments, the cover plate 31 is pivotally connected to the installation housing 35 and combined with one or more of the magnetic buckle 32, the butterfly hinge 34 or the snap fastener 33 according to the practical requirements, so as to form the invisible E-lock door 2 on the bevel plane 12 of the door panel body 10, which not only provides basic protection functions for the electronic lock 20, but also helps to prevent the electronic lock 20 from vandalism by man. Certainly, the present disclosure is not limited thereto.

In the embodiment, the invisible E-lock door 2 further includes a card swipe machine 40. Preferably but not exclusively, the card swipe machine 40 is arranged adjacent to the electronic lock 20, accommodated in the sheltered space 300, and electrically connected to the controller 22. With the card swipe machine 40 added in the shielding space 300 and electrically connected to the electronic lock 20, it is advantageous of realizing the diverse applications of the invisible E-lock door 2. In this way, an electronic device 1 such as the communication power supply cabinet can provide the system administrator with information about the opening or closing of the cabinet door immediately through the installation of the invisible E-lock door 2 of the present disclosure, so as to further improve the security and anti-theft mechanism. At the same time, the related information can be collected through such mobile applications (APP) for recording the date and time accurately when the cabinet door is opened and closed, so that the access control can be further strengthened. Certainly, the present disclosure is not limited thereto.

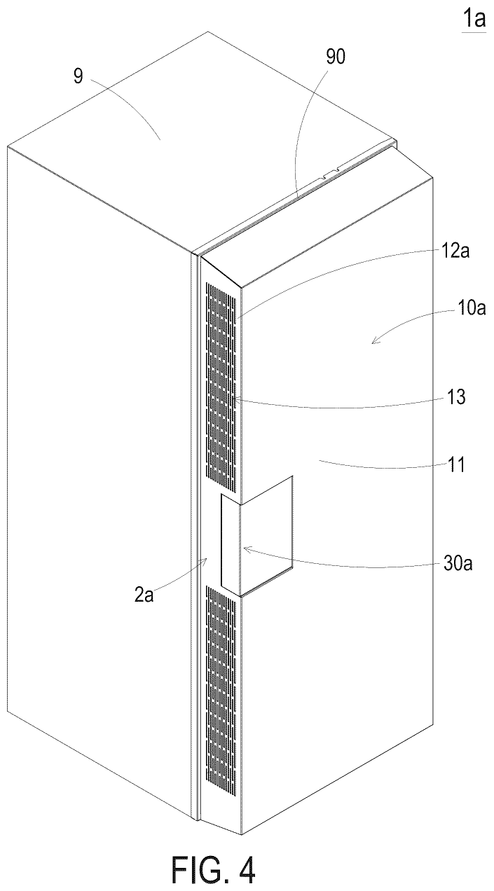

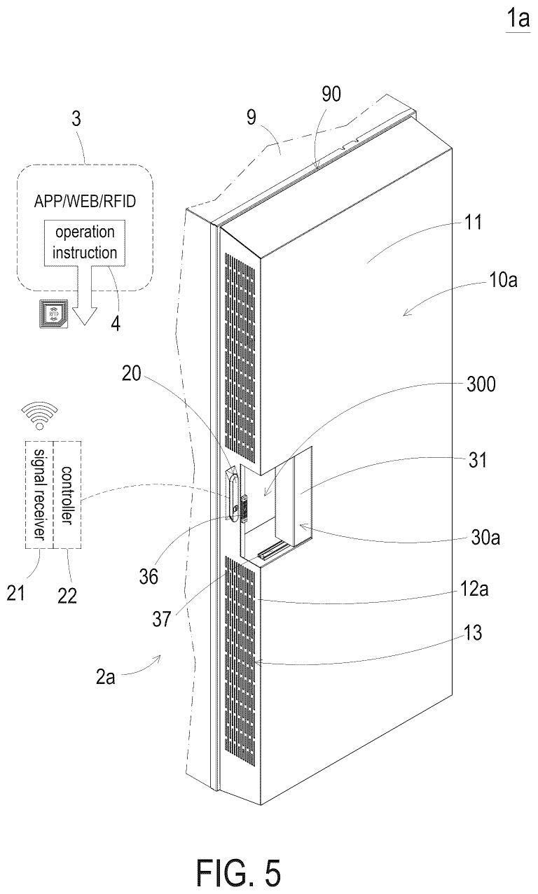

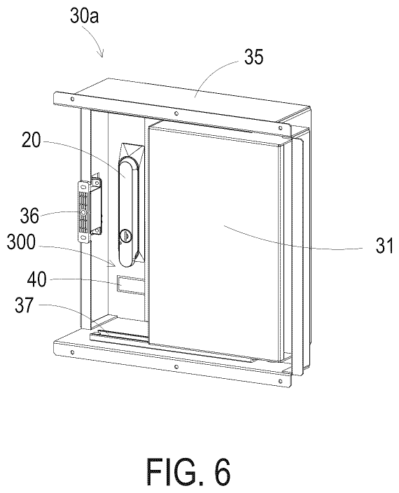

FIG. 4 is a structural perspective view illustrating an electronic device and an invisible E-lock door thereto according to a second embodiment of the present disclosure. FIG. 5 is a schematic structural view illustrating the electronic device and the invisible E-lock door according to the second embodiment of the present disclosure. FIG. 6 shows an exemplary structure of the shielding module in the invisible E-lock door of the present disclosure. In the embodiment, the structures, elements and functions of the electronic device 1a and the invisible E-lock door 2a are similar to those of the electronic device 1 and the invisible E-lock door 2 in FIG. 1 to FIG. 2, and are not redundantly described herein. Please refer to FIG. 4, FIG. 5 and FIG. 6. In the embodiment, the door panel body 10a further includes a lateral plane 12a, which is connected between the front plane 11 of the door panel body 10a and the opening 90 of the cabinet 9. Preferably but not exclusively, a plurality of exhaust holes 13 are disposed on the lateral plane 12a for exhaust and heat dissipation. In the embodiment, the shielding module 30a also adopts a modular design. Preferably but not exclusively, the shielding module 30a includes a cover plate 31, an installation housing 35, a magnetic switch 36 and a sliding rail 37. The installation housing 35 is assembled and embedded between the front plane 11 and the lateral plane 12a of the door panel body 10a, and the electronic lock 20 is preset in the installation housing 35. In the embodiment, the cover plate 31 is slidably mounted on the installation housing 35 through a sliding rail 37, and spatially corresponding to the electronic lock 20. Preferably but not exclusively, the installation housing 35 is embedded in the door panel body 10a, and the sliding rail 37 is parallel to the front plane 11 of the door panel body 10a. In the embodiment, the cover plate 31 and the installation housing 35 are arranged on the door panel body 10a to form the shielding space 300, and the electronic lock 20 is in communication with the exterior through the shielding space 300. Preferably but not exclusively, in the embodiment, the cover plate 31 is L-shaped and corresponding to the front plane 11 and the lateral plane 12a of the door panel body 10a. Preferably but not exclusively, the lateral edge of the cover plate 31 corresponding to the lateral plane 12a is connected to the door panel body 10a through a magnetic switch 36 to seal the shielding space 300 and shield the electronic lock 20. Moreover, the cover plate 31 is allowed sliding away from the magnetic switch 36 through the slide rail 37 to open the shielding space 300 and expose the electronic lock 20. Thereby, the modular shielding module 30a can be detachably embedded into the lateral plane 12a and the front plane 11 of the door panel body 10a to correspond to the position of the electronic lock 20, and the cover plate 31 is allowed sliding in parallel along the front plane 11 of the door panel body 10. When the electronic lock 20 needs to be hidden, the cover plate 31 is operated to seal the shielding space 300. When the electronic lock 20 needs to be viewed, the cover plate 31 is operated to expose the electronic lock 20. Certainly, in other embodiments, the sliding cover plate 31 can be combined with the magnetic switch 36 and the sliding rail 37 according to the practical requirements, thereby constructing the invisible E-lock door 2a between the front plane 11 and the lateral plane 12a of the door panel body 10a, which not only provides basic protection functions for the electronic lock 20, but also helps to prevent the electronic lock 20 from vandalism by man.

In the embodiment, the user allows using the software or hardware of the mobile application (APP), the user web page (WEB) or the radio frequency identification (RFID) system to send the operation instructions 4 through the wireless transmission manner to the signal receiver 21 of the invisible E-lock door 2a in the situation where the electronic lock 20 is hidden and sealed in the sheltered space 300, thereby completing the control of the electronic lock 20. Certainly, the present disclosure is not limited thereto.

In the embodiment, some electronic components such as the card swipe machine 40 can be added in the shielding space 300 formed by the installation housing 35 and the cover plate 31, and electrically connected to the electronic lock 20, so as to realize the diverse applications of the invisible E-lock door 2a. Thereby, the electronic device 1a such as the communication power supply cabinet can provide the system administrator with information about the opening or closing of the cabinet door immediately through the installation of the invisible E-lock door 2a of the present disclosure, so as to further improve the security and anti-theft mechanism. At the same time, the related information can be collected through such mobile applications (APP) for recording the date and time accurately when the cabinet door is opened and closed, so that the access control can be further strengthened. Certainly, the present disclosure is not limited thereto and not redundantly described hereafter.

In summary, the present disclosure provides an invisible E-lock door and an electronic device using the same, having an invisible E-lock cooperated with a cloud-controlled door lock switch through wireless transmission connection, so as to control and confirm the opening and closing of the cabinet door effectively. The invisible E-lock door includes a shielding module to construct a shielding space on the door panel body. An electronic lock is installed in the shielding space, and it allows choosing to shield or expose the electronic lock by operating the shielding module. The shielding module is operated by means of, for example, a pivoting cover or a sliding cover combined with a magnetic buckle, a butterfly hinge, a snap fastener or a magnetic switch, so that the shielding space is capable of being sealed to shield the electronic lock. Alternatively, the shielding space is capable of being opened to expose the electronic lock, thereby allowing the electronic lock to be exposed. In that, an invisible electronic lock is installed on the door panel body. In addition to providing basic protection functions for the electronic lock, it also helps to prevent the electronic lock from vandalism caused by man. On the other hand, the opening and closing operations of the electronic lock are controlled through the cloud-controlled door lock switch, so as to eliminate the inconvenience of users having to carry physical keys with them. The cloud-controlled door lock switch can send an operation instruction through a mobile application (APP), a user web page (WEB) or a radio frequency identification (RFID) system to the signal receiver of the electronic lock in a wireless transmission manner, and then the operation instruction is transmitted to the controller to control the opening and closing of the electronic lock, even if the electronic lock is still shield by the shielding module in an invisible state. In addition, the electronic lock received in the shielding space can be exposed by opening the shielding module when inspection or maintenance is required. Certainly, a card swipe machine can also be added to the electronic lock in the shielding space to realize the diverse applications of the invisible E-lock door. An electronic device such as the communication power supply cabinet can provide the system administrator with information about the opening or closing of the cabinet door immediately through the installation of the invisible E-lock door of the present disclosure, so as to further improve the security and anti-theft mechanism. At the same time, the related information can be collected through such mobile applications or user web pages for recording the date and time accurately when the cabinet door is opened and closed, so that the access control can be further strengthened. The present disclosure includes the industrial applicability and the inventive steps.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An invisible E-lock door, comprising:
a door panel body, arranged on an opening of a cabinet and configured to close or open the opening of the cabinet;
an electronic lock, installed on the door panel body and comprising a controller and a signal receiver, wherein the signal receiver is connected to the controller and configured to receive an operation instruction sent via wireless transmission and transmit the operation instruction to the controller, and the controller controls the electronic lock to turn on or turn off according to the operation instruction; and
a shielding module spatially corresponding to the electronic lock, and configured to selectively shield or expose the electronic lock.

2. The invisible E-lock door according to claim 1, wherein the operation instruction is issued by a mobile application, a user web page or a radio frequency identification system.

3. The invisible E-lock door according to claim 1, wherein the shielding module comprises a cover plate, which is pivotally connected to the door panel body, spatially corresponding to the electronic lock, and configured to form a shielding space in the door panel body, wherein the electronic lock is in communication with an exterior through the shielding space.

4. The invisible E-lock door according to claim 3, wherein the cover plate is connected to the door panel body through a magnetic buckle, a butterfly hinge or a snap fastener to seal the shielding space and shield the electronic lock.

5. The invisible E-lock door according to claim 4, wherein the cover plate is rotated away from the magnetic buckle, the butterfly hinge or the snap fastener to open the shielding space and expose the electronic lock.

6. The invisible E-lock door according to claim 1, wherein the shielding module comprises a cover plate, which is slidably disposed on the door panel body, spatially corresponding to the electronic lock, and configured to form a shielding space in the door panel body, wherein the electronic lock is in communication with an exterior through the shielding space.

7. The invisible E-lock door according to claim 6, wherein the cover plate is connected to the door panel body through a magnetic switch to seal the shielding space and shield the electronic lock.

8. The invisible E-lock door according to claim 7, wherein the cover plate is slid away from the magnetic switch to open the shielding space and expose the electronic lock.

9. The invisible E-lock door according to claim 6, wherein the cover plate is slidably mounted on an installation housing through a sliding rail, the installation housing is embedded in the door panel body, and the sliding rail is parallel to a front plane of the door panel body.

10. The invisible E-lock door according to claim 6, wherein the cover plate is arranged at an inclination relative to a front plane of the door panel body.

11. The invisible E-lock door according to claim 6, wherein the cover plate is L-shaped and corresponding to a front plane and a lateral plane of the door panel body.

12. The invisible E-lock door according to claim 6, further comprising a card swipe machine, wherein the card swipe machine is arranged adjacent to the electronic lock, accommodated in the sheltered space, and electrically connected to the controller.

13. An electronic device, comprising:
a cloud-controlled door lock switch, configured to send an operation instruction through a wireless transmission manner; and
an invisible E-lock door, configured to be controlled by the cloud-controlled door lock switch, and comprising:
a door panel body, arranged on an opening of a cabinet and configured to close or open the opening of the cabinet;
an electronic lock, installed on the door panel body and comprising a controller and a signal receiver, wherein the signal receiver is connected to the controller and configured to receive the operation instruction sent by the cloud-controlled door lock switch and transmit the operation instruction to the controller, and the controller controls the electronic lock to turn on or turn off according to the operation instruction; and
a shielding module spatially corresponding to the electronic lock, and configured to selectively shield or expose the electronic lock.

14. The electronic device according to claim 13, wherein the cloud-controlled door lock switch comprises a mobile application, a user web page or a radio frequency identification system.

15. The electronic device according to claim 13, wherein the shielding module further comprises an installation housing, which is detachably embedded in the door panel body and configured to form a shielding space, and the electronic lock is accommodated in the shielding space.
